(19) United States
(12) Patent Application Publication
(10) Pub. No.: US 2026/0124879 A1
(43) Pub. Date: May 7, 2026

(54) AIR CONDITIONING ASSEMBLY FOR AN ENCLOSURE

(71) Applicant: NB4 Brand L.L.C., d/b/a The Kingstar Company, Chassell, MI (US)

(72) Inventor: Marcus Niemela, Houghton, MI (US)

(21) Appl. No.: 19/376,303

(22) Filed: Oct. 31, 2025

Related U.S. Application Data
(60) Provisional application No. 63/715,835, filed on Nov. 4, 2024.

(51) Int. Cl. B60H 1/24; B60H 1/00

(52) U.S. Cl. CPC B60H 1/245; B60H 1/00364

(57) ABSTRACT

An air conditioning assembly for an enclosure includes a lower vent housing having a pair of side panels that define airflow plenums to improve the ambient airflow through the unit so that the unit is more effectively cooled, and the efficiency of the unit is heightened. The unit draws ambient air into its side vents via the plenums, and further increases ambient airflow by drawing ambient air into its upper vents via an upper vent housing of the assembly. The unit is supported by a platform extending between the side panels and defining a trough for effectively collecting and removing liquids in the assembly. The platform and side panels are unitary to more readily manufacture and install the air conditioning assembly, and are installed within the enclosure such that the unit is also in the enclosure and not extending into the outside environment.

### CROSS REFERENCE TO RELATED APPLICATION

The present application claims the benefit of U.S. provisional application Ser. No. 63/715,835 filed Nov. 4, 2024, which is hereby incorporated herein by reference in its entirety.

### FIELD OF THE DISCLOSURE

The present disclosure relates to air conditioning systems, and, more particularly, to an air conditioning assembly for an enclosure.

### BACKGROUND

Air conditioning systems are installed to regulate temperatures of enclosures including, but not limited to, recreational vehicles, residential buildings, and commercial buildings. The type of air conditioning system installed in an enclosure varies based on its application. In some cases, compact air conditioning systems are installed in smaller enclosures such as, for example, a recreational vehicle or a mobile home.

A window air conditioner unit may be used to regulate the temperature of a smaller room or enclosure. Common components of a window air conditioner unit include a fan that draws air from the enclosure into the unit and directs such air over evaporator coils having refrigerant that absorbs heat from the air. The fan then circulates the cooled air back into the enclosure.

The refrigerant moves from the evaporator coils to condenser coils that dissipate the heat previously absorbed by the refrigerant into ambient air. This is accomplished by another fan in the unit drawing ambient air into the unit and directing such ambient air over condenser coils and to the environment outside of the enclosure for removing the heat dissipated by the condenser coils.

### SUMMARY

An air conditioning assembly for an enclosure includes upper and lower vent housings that define airflow plenums, and an air conditioner unit that draws in ambient air from the plenums to improve ambient airflow through the unit, thereby more effectively cooling the unit such that the efficiency of the unit is increased. The lower vent housing includes side panels that define plenums fluidly coupled to the environment outside of the enclosure and the unit. As such, the unit draws ambient air into the plenums and then into side vents of the unit. The ambient airflow through the unit is further improved by the unit drawing ambient air into upper vents of the unit via the upper vent housing. The air conditioning assembly is particularly well adapted for installation in recreational vehicle (RV) applications, including self-powered RV's, camper trailers, truck campers, boats, and the like, in which protruding components may be problematic for vertical and/or horizontal clearance, for meeting vehicle width restrictions on roadways, and for aesthetics.

The unit is supported by a platform defining a trough that effectively collects and removes liquids in the air conditioning assembly. The platform and the pair of side panels are unitary to more readily manufacture and install the air conditioning assembly, and are installed within the enclosure such that the unit is also in the enclosure and not extending into the outside environment.

In one form of the present disclosure, an air conditioning assembly for an enclosure has a platform to support a unit and a pair of side panels coupled to the platform. The side panels define respective side airflow plenums that extend along opposing surfaces of the unit. The unit is disposed between the side panels and configured to draw ambient air into the side airflow plenums in a first direction, and into the unit in a second direction.

In one aspect, a lower vent housing has the platform and the side panels, and an upper vent housing defines an upper air inlet for ambient air to enter the unit in a third direction perpendicular to the first and second directions.

In another aspect, the platform, the pair of side panels and the unit are disposed inboard of the enclosure.

In yet another aspect, the platform defines a trough that collects liquids in the assembly and the unit.

In yet another aspect, the platform and the side panels are unitary.

In yet another aspect, the platform has opposing side edge portions and a rear edge portion. A first of the side panels have a first wall extending from a first of the side edge portions, and extending from a first portion of the rear edge portion towards the air conditioner unit. A second of the side panels have a second wall extending from a second of the side edge portions, and extending from a second portion of the rear edge portion towards the unit.

In yet another aspect, the side panels further have respective upper panel portions extending from the first and second walls to respective inner edges that define indentations.

In yet another aspect, the assembly has a frame coupled to the side panels and aligned with the upper panel portions and portions of the walls extending along the side edges of the platform. The frame defines a pair of frame plenums fluidly coupled to the respective side airflow plenums. The unit draws ambient air into the frame plenums in the first direction.

In another form of the present disclosure, an air conditioning assembly for an enclosure has a pair of side panels that define respective side airflow plenums for ambient air to enter an air conditioner unit, and a platform extending between the pair of side panels that supports the unit. The platform defines a trough to collect liquids in the assembly and the unit.

In one aspect, the trough defines a liquid outlet fluidly coupled to an opening of the enclosure for liquids to exit the enclosure.

In another aspect, the assembly has a frame coupled to the side panels and the platform. The frame defines frame plenums fluidly coupled to the trough and respective ones of the side airflow plenums. Ambient air enters the side airflow plenums via the frame plenums, and liquids enter the trough via the frame plenums.

In yet another aspect, the frame has a divider panel between the frame plenums. The frame defines a clearance for liquids to enter the trough. The frame plenums are fluidly coupled to the trough via the clearance.

In yet another aspect, the assembly includes a lower vent housing having the platform and the side panels, and an upper vent housing defining an upper air inlet for ambient air to enter the unit. The upper air inlet is fluidly coupled to the trough, and the liquids enter the trough from the upper air inlet via the unit.

In yet another form of the present disclosure, an air conditioning assembly for an enclosure includes an air conditioner unit having a side vent disposed on a side surface of the unit and an upper vent disposed on an upper surface of the unit. The assembly has an upper vent housing defining an upper air inlet for ambient air to enter the upper vent, and a lower vent housing including a side panel defining a side airflow plenum that extends along the side surface of the unit for ambient air to enter the side vent, and a platform extending from the side panel. The platform supports the unit.

In yet another form of the present disclosure, an air conditioning system includes an enclosure having a side surface and an upper surface, an air conditioner unit disposed within the enclosure, and an upper vent housing in a recessed mounted position with respect to the upper surface. The upper vent housing has an upper air inlet for ambient air to enter the unit. The assembly has a lower vent housing in a recessed mounted position with respect to the side surface. The lower vent housing has a pair of side panels defining respective side airflow plenums for ambient air to enter the unit, and a platform extending from a first of the side panels to a second of the side panels. The platform supports the unit.

Thus, the air conditioning assembly heightens the efficiency of the air conditioner unit by improving the ambient airflow through the unit to cool the unit, including its condenser, more effectively. This is accomplished by the assembly including the lower vent housing having the pair of side panels defining the plenums so that the unit draws ambient air into its side vents via the plenums. The unit further draws ambient air into its upper vents via an upper vent housing of the assembly to increase ambient airflow through the unit for further improvement of the efficiency. The air conditioning assembly effectively removes liquids from the assembly by having a trough defined by the lower vent housing that collects and removes such liquids. The trough is defined by a platform that supports the unit and extends between the side panels such that the trough and side panels are unitary to more readily manufacture and install the air conditioning assembly, and are installed within the enclosure such that the unit is also in the enclosure and not extending into the outside environment.

These and other objects, advantages, purposes, and features of this disclosure will become apparent upon review of the following specification in conjunction with the drawings.

### BRIEF DESCRIPTION OF DRAWINGS

FIG. 1 is a front-left perspective view of an enclosure in the form of a truck camper, the enclosure including an air conditioning assembly having an upper vent housing and a lower vent housing;

FIG. 2 is a front-right perspective view of the enclosure shown with roof panel omitted to show interior structures;

FIG. 3 is an exploded rear perspective view of the air conditioning assembly of FIG. 1;

FIG. 4 is a rear perspective view of the of the air conditioning assembly of FIG. 1;

FIG. 5 is a rear perspective view of the air conditioning assembly of FIG. 1 with its upper and rear surface structures omitted to show internal components and plenums;

FIG. 6 is a front, bottom perspective view of the air conditioning assembly of FIG. 1 having the lower vent housing and the air conditioner unit;

FIG. 7 is a front, top perspective view of the lower vent housing of FIG. 1;

FIG. 8 is a rear, top perspective view of the lower vent housing of FIG. 1;

FIG. 9 is a front elevation view of the air conditioning assembly of FIG. 1 having the lower vent housing and the air conditioner unit;

FIG. 10 is a bottom sectional view of the air conditioning assembly of FIG. 1 having the lower vent housing and the air conditioner unit, in correspondence with the section line X-X in FIG. 9;

FIG. 11 is a right side sectional view of the air conditioning assembly of FIG. 1 having the lower vent housing and the air conditioner unit, in correspondence with the section lines XI-XI in FIGS. 9 and 10;

FIG. 12 is a top plan view of the lower vent housing of FIG. 1;

FIG. 13 is a right side elevation view of the lower vent housing of FIG. 1;

FIG. 14 is a top plan view of the enclosure of FIG. 1 showing the upper vent housing;

FIG. 15 is an elevation view of the enclosure of FIG. 1 showing the lower vent housing;

FIG. 16 is a back sectional view of the enclosure of FIG. 1 showing the air conditioning assembly, in correspondence with the section lines XVI-XVI in FIG. 14;

FIG. 17 is a side sectional view of the enclosure of FIG. 1 showing the air conditioning assembly, in correspondence with the section lines XVII-XVII in FIG. 15;

FIG. 18 is a bottom perspective view of the upper vent housing of FIG. 1; and

FIG. 19 is a perspective view of the upper vent housing of FIG. 1 including an air conditioning assembly similar to FIG. 1 having a lower vent housing.

### DESCRIPTION OF THE PREFERRED EMBODIMENTS

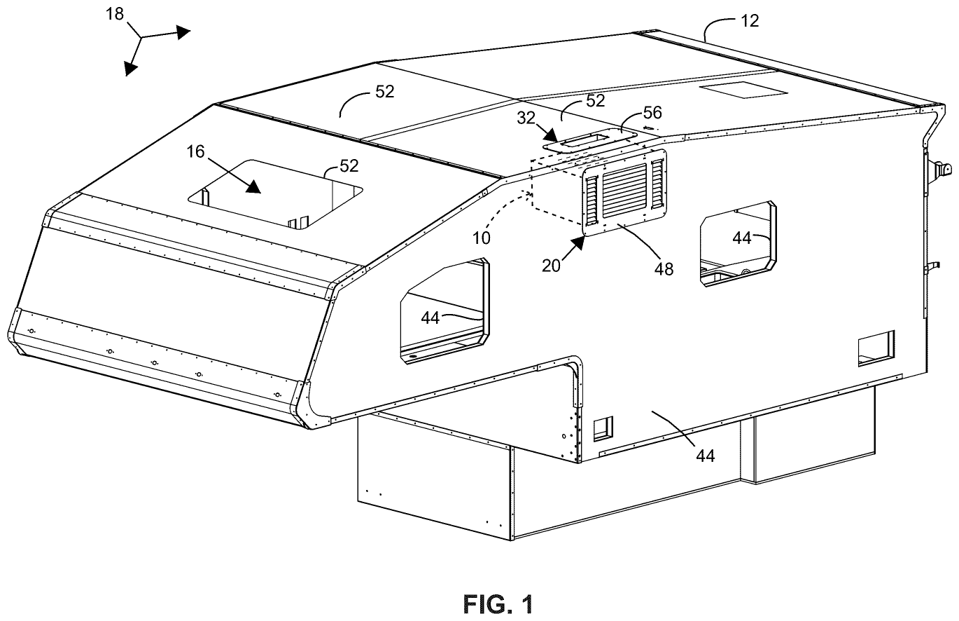

Referring now to the drawings and illustrative embodiments depicted therein, an air conditioning assembly 10 efficiently cools air within an enclosure 12 such as a recreational vehicle (“RV”) as shown in FIG. 1. The air conditioning assembly 10 is installed in a recessed mounted position or configuration with respect to the enclosure 12 so that the air conditioning assembly substantially does not protrude from the exterior walls or surfaces of the enclosure 12. (FIG. 1). For instance, the assembly 10 installed in an RV does significantly increase the overall height or width of the enclosure, and therefore does not affect the enclosure's ability to pass beneath tree branches or other overhead structures, nor the enclosure's ability to pass through narrow spaces such as in parking lots or between trees. Unlike traditional air conditioners designed for mounting atop the roof of a camper or RV, the assembly 10 also does not reduce the aerodynamic drag of the RV or camper while the RV or camper.

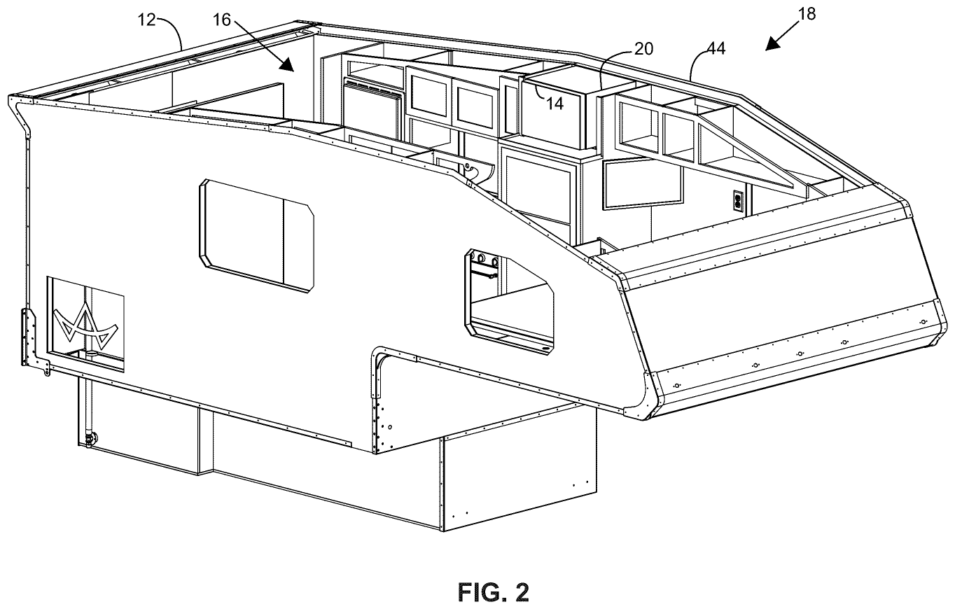

The air conditioning assembly 10 has an air conditioner unit 14 that cools the air within the enclosure 12 by drawing air into the unit 14 from inside the enclosure environment 16 and recirculating the cooled air back into the enclosure environment 16. (FIGS. 1 and 2). Heat drawn out of the enclosure environment 16 is expelled and the unit 14 is cooled by drawing in ambient air from the outside environment 18 (i.e., space outside the enclosure 12) into the unit 14 and discharging the ambient air back into the outside environment 18. (FIG. 1).

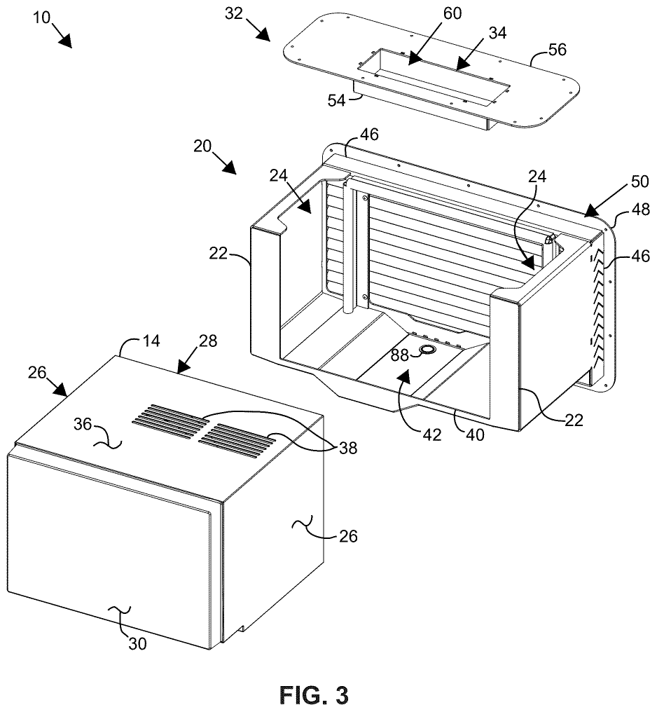

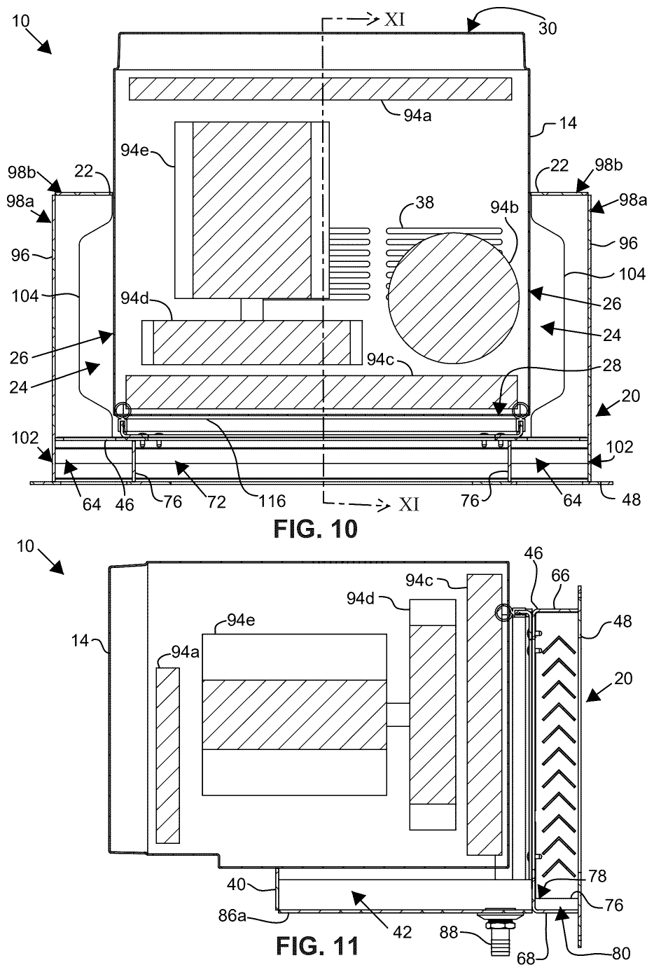

The air conditioner unit 14 draws ambient air into a lower or side vent housing 20 of the air conditioning assembly 10 through an exterior side plate 48. (FIGS. 1, 3). The unit 14 is disposed between a pair of side panels 22 of the lower vent housing 20 that define respective side airflow or intake plenums 24 fluidly coupled to the outside environment 18 and the unit 14, and the side intake plenums 24 extend along opposing side surfaces 26 of the unit 14 having side intake vents (not shown) so that the unit 14 draws cooler outside ambient air into side vents via the side intake plenums 24. (FIGS. 3, 4, 10). The unit directs the cooler outside ambient air through the unit 14 such that the ambient air is heated from passing through and cooling the unit 14, in particular the unit's condenser, and the resultant heated ambient air is discharged via a central front vent on a front surface 28 of the unit 14 that opposes a rear surface 30 of the unit 14. (FIGS. 3, 10).

Additional outside ambient air is drawn into the air conditioner unit 14 for cooling the unit 14 and its condenser via an upper vent housing 32 of the air conditioning assembly 10. (FIGS. 1, 3). The upper vent housing 32 is separate from the lower vent housing 20, and defines an upper air inlet 34 fluidly coupled to the outside environment 18. The upper vent housing 32 extends along the upper surface 36 of the unit 14 so that the unit 14 draws the ambient air into upper vents 38 on the upper surface 36 via the upper air inlet 34. (FIGS. 1, 4, 14).

The lower or side vent housing 20 has a platform 40 that supports the air conditioner unit 14 and defines a trough 42 for collecting and removing liquids in the air conditioning assembly 10. (FIG. 3). The platform 40 is coupled to the pair of side panels 22 and extends between the pair of side panels 22 such that the platform 40 and the pair of side panels 22 are unitary (i.e., a structure formed from one piece of material) to more readily install and manufacture the lower vent housing 20, while avoiding the use of welds, fasteners, or sealants that may increase the likelihood of a leak developing during production or while in service. (FIG. 3).

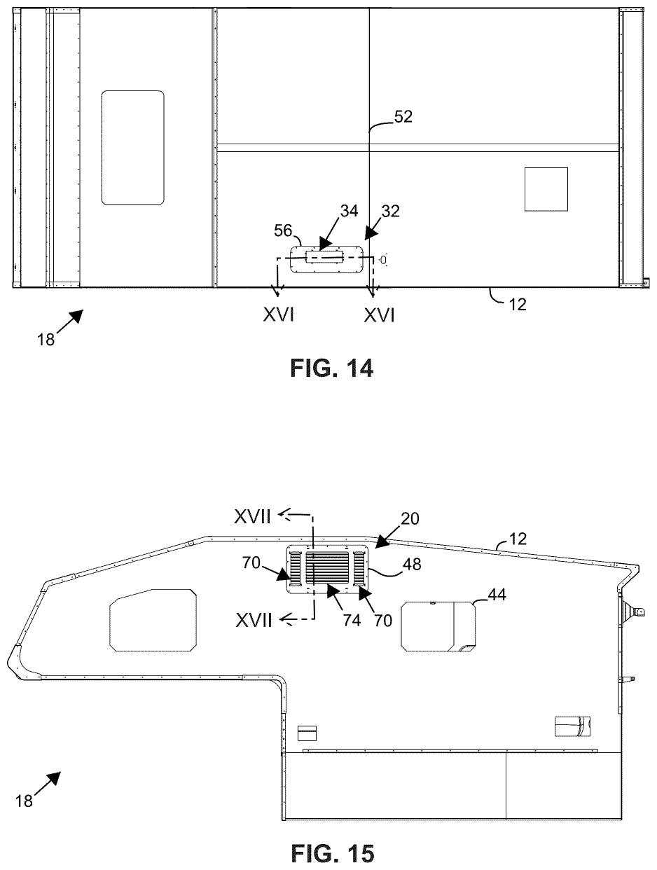

Thus, the air conditioning assembly 10 efficiently cools air in an enclosure 12 by drawing in a sufficient amount of ambient air to cool the air conditioner unit 14 via the side intake plenums 24 defined by the pair of side panels 22 of the lower vent housing 20, and via the upper air inlet 34 defined by the upper vent housing 32. Liquids in the assembly 10, which may be a product of condensed water vapor dripping from the unit's evaporator and rainwater entering through upper air inlet 34 are effectively channeled into the trough 42 defined by the platform 40 of the lower vent housing 20. The pair of side panels 22, the platform 40, and the unit 14 are disposed inboard of the enclosure 12 (i.e., within the enclosure environment 16) and do not substantially extend into the outside environment 18 so as to avoid any protruding components that would significantly increase the overall width of the enclosure 12. (FIGS. 14-17).

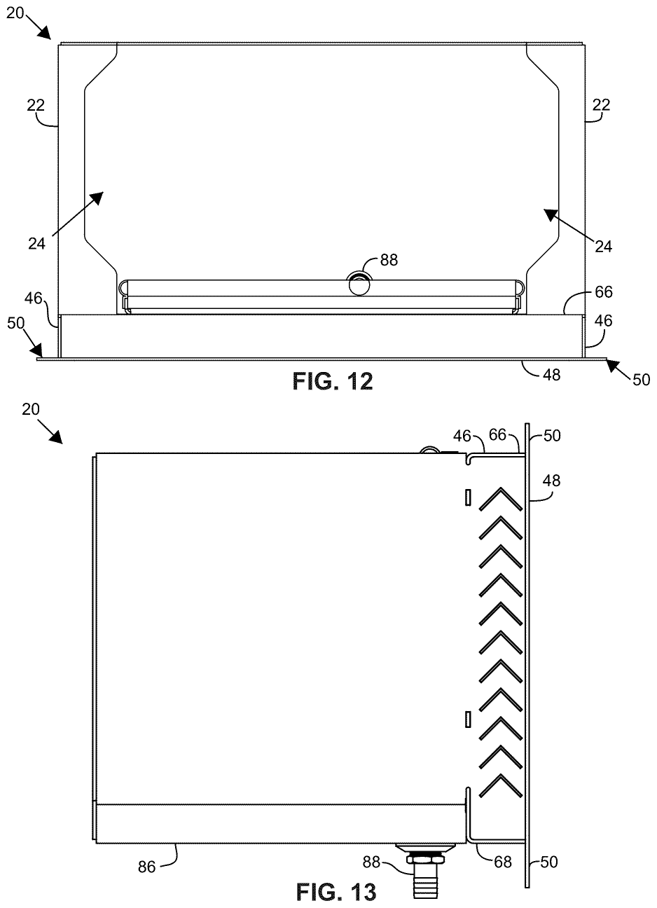

Referring to FIGS. 1 and 3, the air conditioning assembly 10 is installed in a recessed mounted position with respect to a side wall 44 of the enclosure 12. The side wall 44 defines an opening that is aligned with a frame 46 coupled to the pair of side panels 22 of the lower vent housing 20 so that the frame 46 inserts from the outside environment 18 and into such opening for installation of the lower vent housing 20. (FIGS. 1-3). The frame 46 is coupled to an outer face plate 48 that has a lip portion 50 extending perpendicularly away from the frame 46. (FIGS. 3, 12, 13). The lip portion 50 of the outer face plate 48 is coupled to the side wall 44 of the enclosure 12 such that the lower vent housing 20 may be fixed to the enclosure 12. (FIGS. 1, 3, 15).

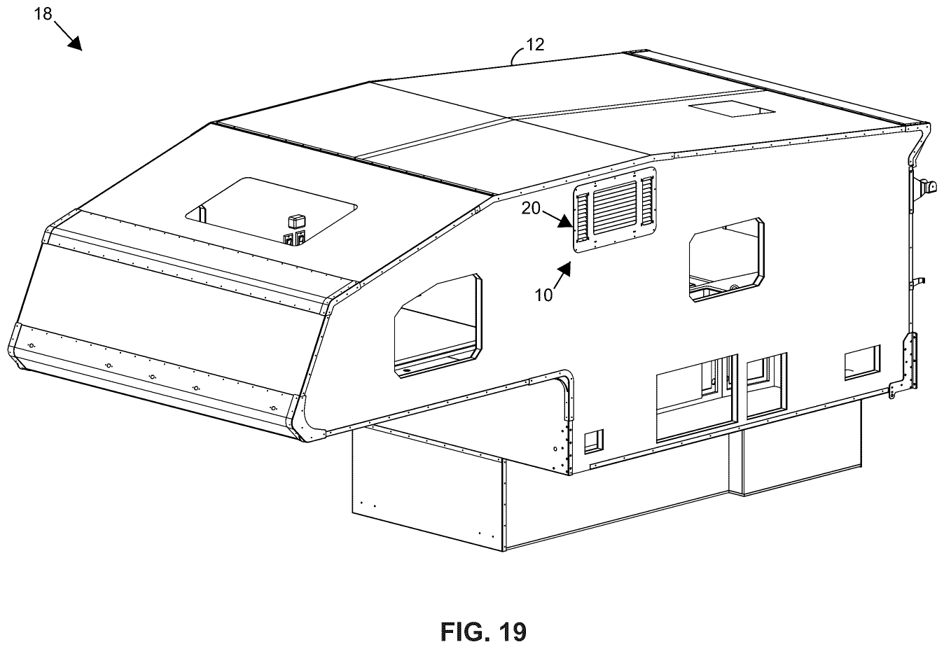

The air conditioning assembly 10 is further installed in a recessed mounted configuration or position with respect to an upper roof panel 52 of the enclosure 12. (FIGS. 1, 3). The upper roof panel 52 defines an upper opening that is aligned with a channel 54 of the upper vent housing 32 so that the channel 54 inserts from the outside environment 18 and into such upper opening for installation of the upper vent housing 32. (FIGS. 1, 3). As best shown in FIG. 18, the upper vent housing 32 has an upper face plate 56 that extends perpendicularly from an upper end 58 of the channel 54. The upper plate 56 is coupled to the upper roof panel 52 of the enclosure 12 such that the upper vent housing 32 may be fixed to the enclosure 12. (FIGS. 1, 3).

As such, the upper face plate 56 of the upper vent housing 32 and the outer face plate 48 of the lower vent housing 20 are the elements of the air conditioning assembly 10 outboard of the enclosure 12, and the remaining portions (e.g., the unit 14, the pair of side panels 22, the platform 40, the frame 46, the channel 54) are disposed inboard of the enclosure 12. (FIGS. 1, 14-17). In other words, the upper face plate 56 and the outer face plate 48 are in the outdoor environment 18, and the remaining portions are in the enclosure environment 16. (FIGS. 14, 15). The face plates 48, 56 do not substantially protrude from the roof panel 52 or side panel 44 (respectively) to the extent that they are thin and generally planar structures, typically having a thickness of less than one quarter inch, and perhaps less than one eighth inch. It should further be understood that “does not substantially protrude” means that no mechanical components of the AC unit and no vent or intake pipes extend outwardly from outer surfaces of the enclosure 12. The face plates 48, 56 may be sealed to the respective panels 44, 52 of the enclosure 12 with silicone-based sealants or the like, gaskets, weatherstripping, or other sealing materials or structures, and may be further mechanically fastened using screws, bolts, or the like.

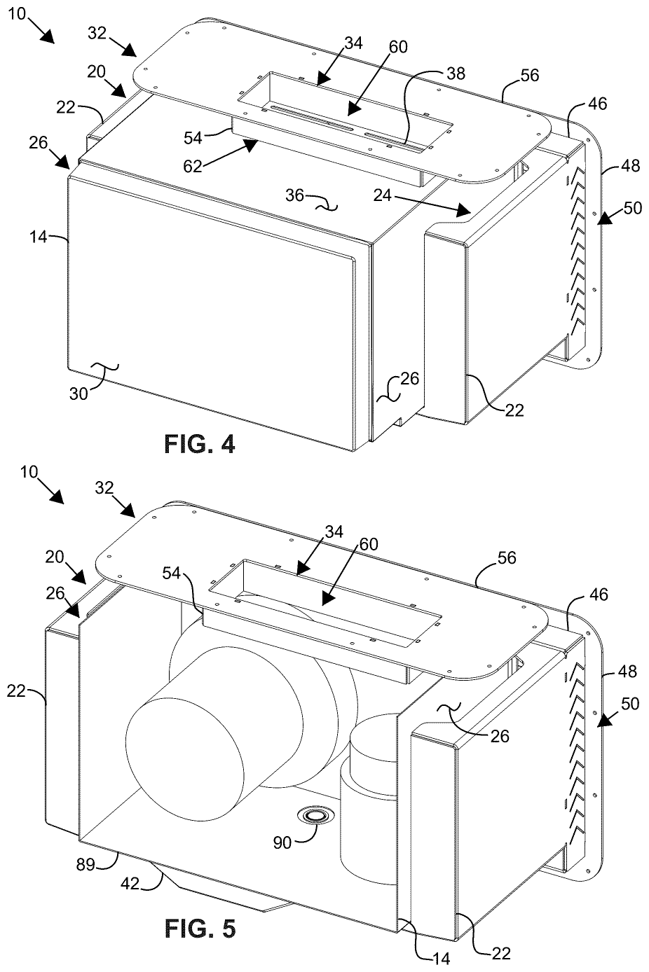

Referring to FIG. 4, the channel 54 and upper face plate 56 of the upper vent housing 32 define the upper air inlet 34 that is fluidly coupled to the upper vents 38 (FIG. 3) via an upper plenum 60 defined by the channel 54 of the upper vent housing 32. The channel 54 has a lower end 62 coupled to the upper surface 36 of the air conditioner unit 14, and the upper plenum 60 extends away from the upper surface 36 of the unit 14 so that the unit 14 draws the ambient air in a vertical direction from the outside environment 18 that is above the roof panel 52 and into the upper air inlet 34, the upper plenum 60, and then the upper vents 38 to cool the unit 14 and its condenser. (FIGS. 4 and 14). The upper vent housing 32 thus guides ambient air downwardly through the upper air inlet 34 and the channel 54 into the upper vents 38.

Referring to FIGS. 9, 10 and 15, the unit 14 draws ambient air into the side vents of the unit 14 via the side intake plenums 24 defined by the pair of side panels 22 that are fluidly coupled to the outside environment 18 via a pair of side frame plenums 64 defined between upper and lower frame panels or plates 66, 68 of the frame 46, and via side air inlets 70 defined by the outer face plate 48. As such, the unit 14 draws the ambient air from the outside environment 18 that is along the side wall 44 and into the side air inlets 70 and the side frame plenums 64 in a rearward horizontal direction (e.g., aligned with the side surfaces 26 of the unit 14 towards the rear surface 30 of the unit 14), and then into the side vents in lateral directions perpendicular to the rear horizontal direction for cooling the unit 14, which is a lateral inboard direction with respect to the enclosure 12 of FIGS. 1 and 2. The frame 46 thus guides ambient air through the side frame plenums 64 and into the side intake plenums 24, and the side panels 22 guide ambient air through the side intake plenums 24 into the side vents.

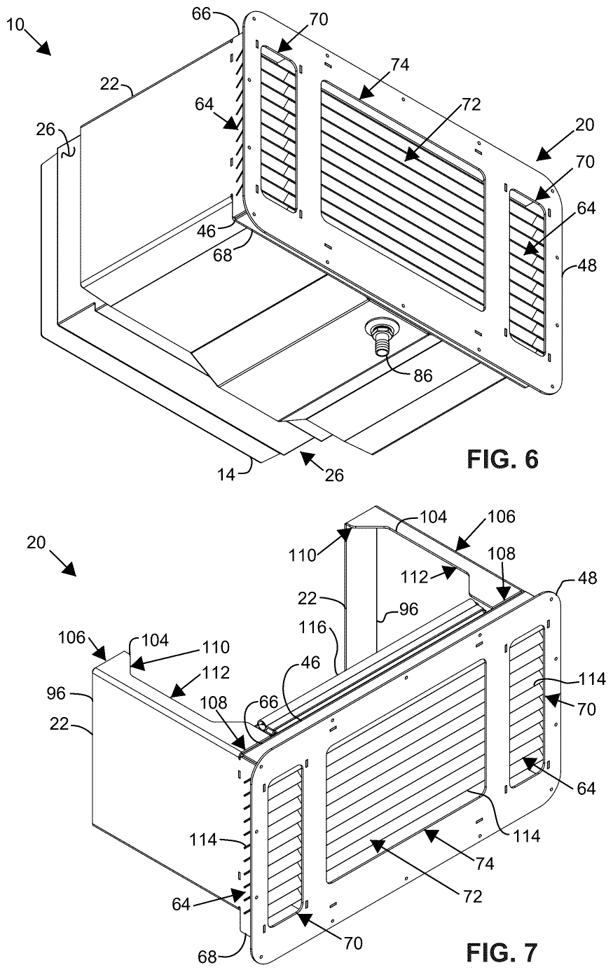

The ambient air from the upper and side air inlets 34, 70 is directed through the unit 14 and exits the unit 14 as heated ambient air into the outside environment 18 in a lateral outboard direction (e.g., opposite the lateral inboard direction) via a front vent (not shown) on the front surface 28 of the unit 14. (FIGS. 3, 14-15). The front vent is fluidly coupled to the outside environment 18 via a middle frame plenum 72 defined between the upper and lower frame panels 66, 68 of the frame 46, and via a middle air outlet 74 defined by the outer face plate 48. (FIGS. 6-8, 15). As such, the unit 14 directs heated ambient air from the front vent of the unit 14, the middle frame plenum 72, the middle air outlet 74, and back out into the outside environment 18 to cool the unit 14 and its condenser. (FIGS. 6-8, 15).

Referring to FIGS. 10 and 11, the middle frame plenum 72 is separated from the side frame plenums 64 by divider panels 76 extending between the frame plenums 64, 72 from the upper frame panel 66 to lower divider ends 78 of the divider panels 76. There is a clearance region 80 between the lower divider ends 78 and the lower frame panel 68 that is fluidly coupled to the side and middle frame plenums 64, 72 and the trough 42 of the platform 40. As such, the frame 46 guides liquids entering the plenums 64, 72 via the side air inlets 70 and the middle air outlet 74 such that the liquids flow out of the frame 46 and into the trough 42 via the clearance 80. (FIGS. 9-11).

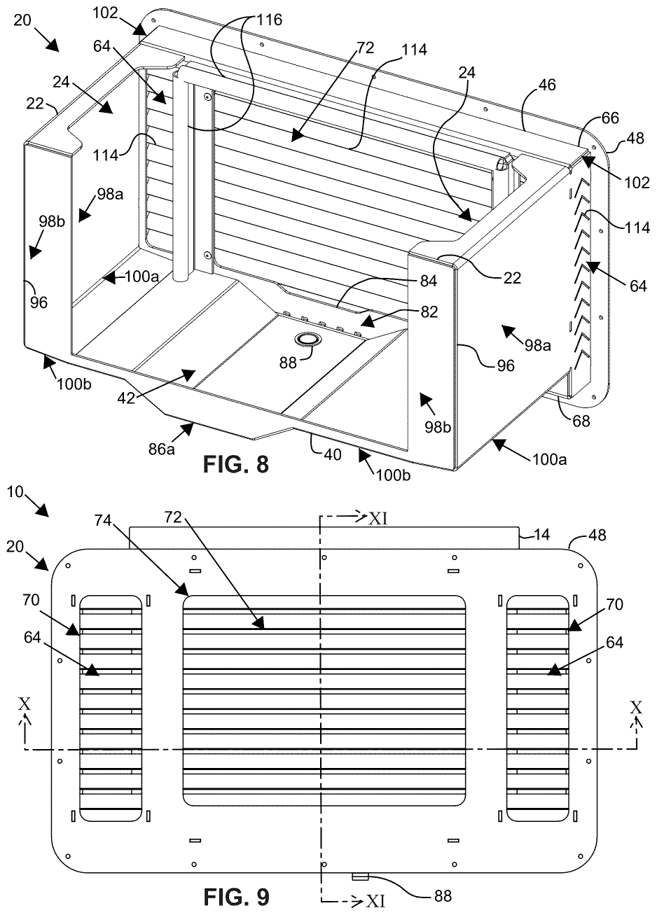

Referring to FIGS. 8 and 11, the clearance region 80 is fluidly coupled to the trough 42 via frame liquid outlet openings 82 defined through a side frame panel 84 of the frame 46 that extends perpendicularly from the lower frame panel 68. The lower frame panel 68 is aligned with a lower trough portion 86a of the platform 40 that defines a trough liquid outlet 88 fluidly coupled to the trough 42 so that liquids can exit the air conditioning assembly 10.

Referring to FIG. 5, the air conditioner unit 14 has a lower panel 89 defining a unit liquid outlet 90 to direct liquids from the unit 14 into the trough 42. The unit liquid outlet 90 is fluidly coupled to the trough liquid outlet 88 (FIG. 3) via the trough 42 so that liquids in the unit 14 will drain from the unit 14 and the assembly 10. The liquids in the unit 14 may include rainwater that enters through the upper air inlet 34 of the upper vent housing 32 and into the unit 14 via its upper vents 38. The rainwater falls onto the lower panel 89, which channels the rainwater through the unit liquid outlet 90 to the trough 42.

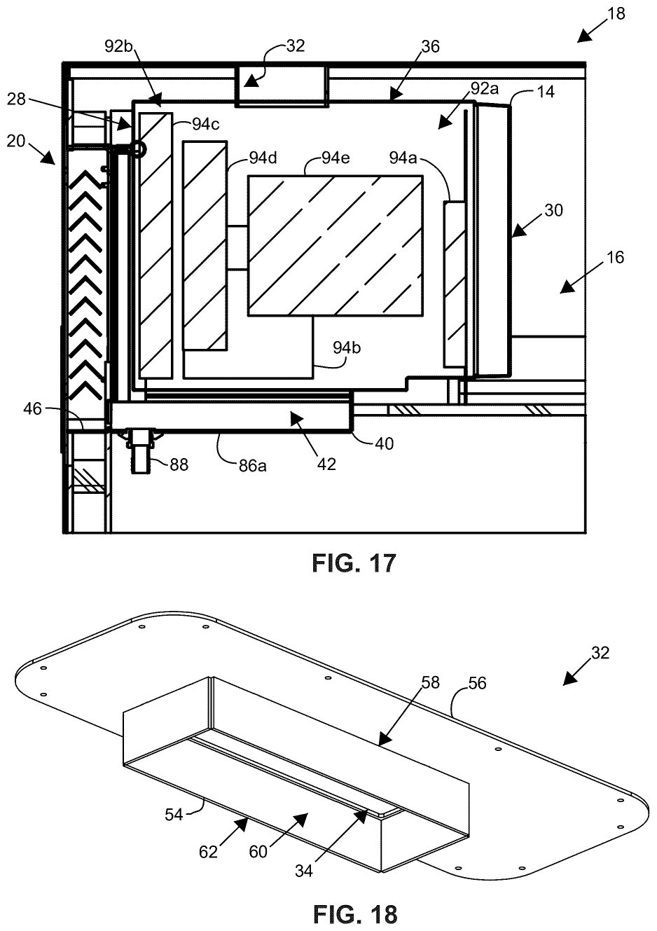

Other liquids in the unit 14 include condensate liquids formed by evaporator coils 94a of the unit 14 during operation. (FIG. 17). For instance, while the unit 14 operates, a fan (not shown) in the enclosure side 92a of the unit 14 directs enclosure air from the enclosure environment 16 around the evaporator coils 94a having refrigerant that absorbs heat from the enclosure air to cool it. As the enclosure air passes over the cold evaporator coils 94a, if the enclosure air has a dewpoint that is higher than the temperature of the evaporator coils 94a, condensation forms along the coils 94a within the unit 14, and condensate liquids fall from the coils 94a onto the lower panel 89 of unit 14 that channels the liquids for draining through the unit liquid outlet 90. (FIGS. 5, 17).

Referring to FIG. 17, the fan in the enclosure side 92a draws the enclosure air into the enclosure side 92a via a rear vent on the rear surface 30 of the unit 14, and directs the cooled enclosure air that passed over the evaporator coils 94a into the enclosure environment 16 via another rear vent on the rear surface 30 of the unit 14. As such, heat from the enclosure air is removed by the refrigerant moving through the evaporator coils 94a.

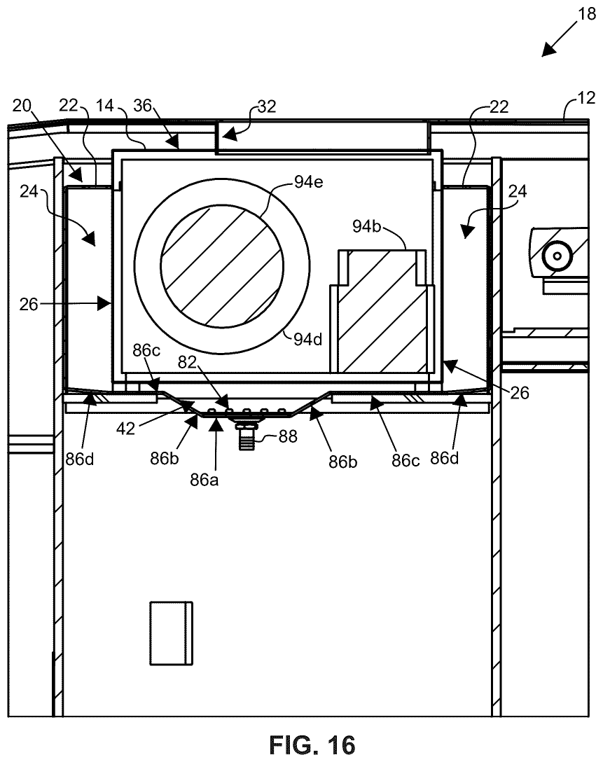

The refrigerant is received by the evaporator coils 94a in liquid form, and the refrigerant expands into gas form as it moves through the evaporator coils 94a. (FIG. 17). The refrigerant in gas form is delivered to a compressor 94b that compresses the refrigerant into liquid form for condenser coils 94c in the ambient side 92b of the unit 14 that dissipate heat previously absorbed by the refrigerant while moving through the evaporator coils 94a in the enclosure side 92a. (FIGS. 16, 17). The dissipated heat is removed from the unit 14 by a fan 94d in the ambient side 92b that draws the cool ambient air into the ambient side 92b via the upper vent housing 32 and the lower vent housing 20, directs the cool ambient air over condenser coils 94c to cool the refrigerant in the condenser coils 94c, and directs the heated ambient air that passed over the condenser coils 94c into the outside environment 18 via the lower vent housing 20.

The fan 94d on the ambient side 92b is driven by a fan motor 94e of the unit 14. The ambient and enclosure sides 92a-b are divided so that the enclosure air and the ambient air are isolated from one another inside the unit 14. As such, the movement of ambient air through the unit 14 in the ambient side 92b removes heat from the unit 14 that dissipated as the refrigerant moves through the condenser coils 94c, and the movement of enclosure air through the unit 14 in the enclosure side 92a cools enclosure air by the refrigerant absorbing heat from the enclosure air as the refrigerant moves through the evaporator coils 94a.

The refrigerant in liquid form is received by the evaporator coils 94a from the condenser coils 94c such that the refrigerant expands back into gas form for the compressor 94b. As such, the compressor 94b, the condenser coils 94c, and the evaporator coils 94a are in fluid communication and form a loop of piping.

Although the air conditioner unit 14 in the embodiments have components 94a-e, it will be apparent to those skilled in the art that air conditioner unit 14 can be implemented in many other ways.

As discussed previously, the trough liquid outlet 88 defined by the lower trough portion 86a of the platform 40 is fluidly coupled to the frame liquid outlet 82 and the unit liquid outlet 90 so that liquids can exit the air conditioning assembly 10. (FIGS. 5, 8). The trough liquid outlet 88 is also fluidly coupled to an opening defined by the enclosure 12 so that fluids can exit the enclosure 12. For example, a hose may be coupled to the trough liquid outlet 88 and extend downwardly through the side wall 44 of the enclosure 12 until terminating at an open end at or near a bottom surface of the enclosure 12. The hose provides a passageway for liquids exiting the air conditioning assembly 10.

Referring to FIG. 16, the lower trough portion 86a is between side trough portions 86b of the platform 40 that extend laterally from the lower trough portion 86a at an angle with respect to the lower trough portion 86a and towards the air conditioner unit 14. As such, the lower and side trough portions 86a-b cooperate to define the trough 42. The trough 42 extends between support portions 86c of the platform 40 that support the unit 14, and the support portions 86c are coupled to outer portions 86d of the platform 40 that further define the side intake plenums 24 defined by the pair of side panels 22.

Referring to FIGS. 8 and 10, the pair of side panels 22 include respective walls 96 having side portions 98a that extend perpendicularly from opposing side edges 100a of the platform 40 and align with opposing ends 102 of the frame. The walls 96 have rear portions 98b that extend from portions of a rear edge 100b of the platform 40 and extend perpendicularly from the side portions 98a of the walls 96 towards the unit 14. (FIGS. 8, 10). The side portions 98a extend along portions of the side surfaces 26 of air conditioner unit 14 having the side vents, and ambient air enters the side vents by entering the side intake plenums 24 in a rear horizontal direction (e.g., aligned with the side portions 98a and towards the rear portions 98b), and entering the unit 14 in lateral directions perpendicular to the horizontal direction (e.g., aligned with the rear portions 98b).

Referring to FIG. 7, the pair of side panels 22 have respective upper panel portions 104 laterally aligned with the upper frame panel 66 of the frame 46, and extending from upper wall edges 106 of the walls 96 and front edges 108 of the upper panel portions 104 to inner edges 110 of the upper panel portions 104 that define indentations 112. (FIGS. 7, 10).

The frame 46 has louvers 114 and a bug screen (not shown) between the upper and lower panels 66, 68 to keep unwanted elements (e.g., debris, dirt, bugs) out of the air conditioner unit 14. (FIGS. 7, 8). The frame 46 is coupled to a gasket 116 of the lower vent housing 20 that is between the frame 46 and the front surface 28 of the unit 14 to separate ambient air exiting and entering the unit 14. (FIG. 10). The gasket 116 surrounds a portion of the middle frame plenum 72 so that the gasket 116 is between the side and middle frame plenums 64, 72, and between the pair of side panels 22 to direct the heated ambient air out of the air conditioning assembly 10 via the middle frame plenum 72. (FIG. 8).

While example implementations of the air conditioning assembly 10 are shown in the figures, one or more of the illustrated elements may be combined, divided, re-arranged, omitted, and/or implemented in any other way. For example, the upper vent housing 32 may be omitted as shown in FIG. 19. In another example, the louvers 114 and gasket 116 may be omitted. In yet another example, the upper vent housing 32 may have louvers and a gasket similar to the louvers 114 and the gasket 116. In yet another example, one of the side panels 22, side air inlets 70, and side frame plenums 64 are omitted.

Further, the air conditioning assembly 10 shown in the figures may include one or more elements in addition to, or instead of, those illustrated, and/or may include more than one of any or all of the illustrated elements. For example, the air conditioning assembly 10 may have another lower vent housing and/or another upper vent housing that directs air into the unit 14.

Accordingly, the air conditioning assembly includes a lower vent housing having a pair of side panels that define side intake plenums fluidly coupled to an air conditioning unit, and an upper vent housing defining an upper air inlet fluidly coupled to the unit for improving ambient airflow through the unit such that the unit is more effectively cooled. The lower vent housing has a platform for supporting the unit and defining a trough that effectively collects and removes liquids that may enter via the lower and upper vent housings and that may form in the air conditioner unit. The platform and the pair of side panels are unitary for reducing the likelihood of water and air leaks forming during manufacture or during years of service. The lower and upper vent housings are installed in a mounted configuration with respect to the enclosure to reduce hazards associated with a standard rooftop or wall air conditioning units that extend into the outside environment.

“Including”, “comprising”, and “having” (and all forms and tenses thereof) are used herein to be open ended terms. Thus, whenever a claim employs any form of “include”, “comprise”, or “have” (e.g., comprises, includes, has, comprising, including, having, etc.) as a preamble or within a claim recitation of any kind, it is to be understood that additional elements, terms, etc. may be present without falling outside the scope of the corresponding claim or recitation.

As used herein, singular references (e.g., “a”, “an”, “first”, “second”) do not exclude a plurality. The term “a” or “an” entity, as used herein, refers to one or more of that entity. The terms “a” (or “an”), “one or more”, and “at least one” can be used interchangeably herein. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C.

Spatial and functional relationships between elements are described using various terms, including “coupled”, “disposed”, “cooperate”, “extends from”, “extends perpendicularly from” “lateral”, “upper”, “lower”, “side”, “middle”, “front”, and “rear”. Unless a relationship between first and second elements are explicitly claimed as being “direct”, such relationship can be either a direct or an indirect relationship. A direct relationship is where no other intervening elements are present between the first and second elements, whereas an indirect relationship is where one or more intervening elements are present (either spatially or functionally) between the first and second elements.

Spatial relationship and direction descriptors are used merely for convenience of description, and are not to be limiting as it should be appreciated that the air conditioning assembly may be used in any desired orientation. Thus, whenever elements and directions are described as “lateral”, “upper”, “lower”, “side”, “middle”, “front”, “rear”, “horizontal”, “vertical” in the description and/or the claims, this does not limit the orientations of the air conditioning assembly as other orientations of the air conditioning assembly may be used.

Changes and modifications in the specifically described embodiments can be carried out without departing from the principles of the present disclosure which is intended to be limited only by the scope of the appended claims, as interpreted according to the principles of patent law including the doctrine of equivalents.

1. An air conditioning support assembly for an enclosure, said air conditioning support assembly comprising:
a lower housing including:
a pair of side panels defining respective side airflow plenums, said side panels configured to guide ambient air through said side airflow plenums and laterally into an air conditioner unit disposed between said side panels, and
a platform coupled to and extending between said side panels, said platform configured to support the air conditioner unit laterally inboard of a wall panel of the enclosure; and
an upper housing separate from said lower housing, said upper housing defining an upper air inlet and configured to guide ambient air through said upper air inlet and downwardly into the air conditioner unit, said upper housing configured to be above the air conditioner unit.

2. The air conditioning support assembly of claim 1, wherein said platform is unitary with said side panels.

3. The air conditioning support assembly of claim 2, wherein said lower housing is configured to be in a recessed mounted position with respect to the wall panel, and said upper housing is configured to be in a recessed mounted position with respect to a roof panel of the enclosure.

4. The air conditioning support assembly of claim 1, wherein said platform defines a trough configured to collect liquids entering said upper air inlet and condensate liquids from the air conditioner unit.

5. The air conditioning support assembly of claim 4, further comprising a frame coupled to said side panels and said platform, wherein said frame defines frame plenums fluidly coupled to said trough and respective ones of said side airflow plenums, and said frame is configured to guide ambient air entering said frame plenums into respective ones of said side airflow plenums, and to guide liquids entering said frame plenums into said trough.

6. The air conditioning support assembly of claim 5, wherein said frame comprises opposing upper and lower plates, and a divider panel between said frame plenums, wherein a clearance is defined between said divider panel and said lower plate, and said frame is configured to guide liquids entering said frame plenums into said trough via said clearance.

7. The air conditioning support assembly of claim 4, wherein said upper air inlet is configured to be fluidly coupled to said trough via the air conditioner unit.

8. The air conditioning support assembly of claim 1, wherein said platform comprises opposing side edge portions and a rear edge portion, wherein a first of said side panels comprises a first wall including a first side portion extending from a first of said side edge portions, and a first rear portion extending from a first portion of said rear edge portion, wherein a second of said side panels comprises a second wall including a second side portion extending from a second of said side edge portions, and a second rear portion extending from a second portion of said rear edge portion, wherein said first and second rear portions of said first and second walls are configured to extend toward the air conditioner unit.

9. The air conditioning support assembly of claim 8, wherein said side panels comprise respective upper panel portions extending from said first and second walls to respective inner edges that define indentations.

10. The air conditioning support assembly of claim 8, further comprising a frame coupled to said side portions of said first and second walls, said frame defining a pair of frame plenums fluidly coupled to respective ones of said side airflow plenums, wherein said frame is configured to guide ambient air through said frame plenums and into said side airflow plenums.

11. The air conditioning support assembly of claim 1, wherein a first of said side panels is configured to guide ambient air through a first of said side airflow plenums such that ambient air enters laterally into said first side airflow plenum in a first direction and enters laterally into the air conditioner unit in a second direction, wherein a second of said side panels is configured to guide ambient air through a second of said side airflow plenums such that ambient air enters laterally into said second side airflow plenum in the first direction and enters laterally into the air conditioner unit in a third direction opposite to the second direction.

12. The air conditioning support assembly of claim 11, wherein said lower housing is configured to be coupled to the wall panel of the enclosure, and said upper housing is configured to be coupled to a roof panel of the enclosure.

13. An air conditioning support assembly for an enclosure, said air conditioning support assembly comprising:
a pair of side panels defining respective side airflow plenums, said side panels configured to guide ambient air through said side airflow plenums and into an air conditioner unit disposed between said side panels; and
a platform coupled to and extending between said side panels, said platform configured to support the air conditioner unit laterally inboard of a wall panel of the enclosure, wherein said platform defines a trough configured to collect liquids entering said air conditioning support assembly and condensate liquids from the air conditioner unit.

14. The air conditioning support assembly of claim 13, further comprising a frame coupled to said side panels and said platform, wherein said frame defines frame plenums fluidly coupled to said trough and respective ones of said side airflow plenums, and said frame is configured to guide ambient air entering said frame plenums into respective ones of said side airflow plenums, and to guide liquids entering said frame plenums into said trough.

15. The air conditioning support assembly of claim 13, wherein said trough defines a liquid outlet fluidly coupled to a passageway of the enclosure for liquids to exit the enclosure.

16. An air conditioning assembly for an enclosure, said air conditioning assembly comprising:
a lower housing configured to be coupled to a wall panel of the enclosure, said lower housing including:
a platform, and
a side panel extending from said platform and defining a side airflow plenum, said side panel configured to guide ambient air through said side airflow plenum;
an upper housing separate from said lower housing, said upper housing configured to be coupled to a roof panel of the enclosure, said upper housing defining an upper air inlet and configured to guide ambient air through said upper air inlet; and
an air conditioner unit supported by said platform and including a side vent and an upper vent, said air conditioner unit configured to be disposed entirely within the enclosure, draw ambient air into said side vent via said side airflow plenum, and draw ambient air into said upper vent via said upper air inlet.

17. The air conditioning assembly of claim 16, wherein said platform is unitary with said side panel, and said platform defines a trough configured to collect liquids entering said upper air inlet and condensate liquids from said air conditioner unit.

18. The air conditioning assembly of claim 17, wherein said lower housing is configured to be in a recessed mounted position with respect to an outer surface of the wall panel, and said upper housing is configured to be in a recessed mounted position with respect to an outer surface of the roof panel.

19. The air conditioning assembly of claim 16, wherein said side vent, said side panel, and said side airflow plenum are a first side vent, a first side panel, and a first side airflow plenum, respectively, said air conditioning assembly comprising a second side panel extending from said platform and defining a second side airflow plenum, said second side panel configured to guide ambient air through said second side airflow plenum, and wherein said air conditioner unit comprises a second side vent and is configured to draw ambient air into said second side vent via said second side airflow plenum.

20. The air conditioning assembly of claim 16, in combination with said enclosure, wherein said enclosure comprises a camper or a recreational vehicle or a boat.
